(19) United States
(12) Patent Application Publication
(10) Pub. No.: US 2021/0193165 A1
(43) Pub. Date: Jun. 24, 2021

(54) COMPUTER APPARATUS AND METHOD IMPLEMENTING COMBINED SOUND RECOGNITION AND LOCATION SENSING

(71) Applicant: Audio Analytic Ltd, Cambridgeshire (GB)

(72) Inventors: Christopher James Mitchell, Cambridgeshire (GB); Sacha Krstulovic, Cambridgeshire (GB); Neil Cooper, Cambridgeshire (GB); Julian Harris, Cambridgeshire (GB)

(21) Appl. No.: 16/718,811

(22) Filed: Dec. 18, 2019

(51) Int. Cl. G10L 25/51; G06F 16/903; H04W 4/02

(52) U.S. Cl. CPC G10L 25/51; H04W 4/02; G06F 16/90335

(57) ABSTRACT

A computing device, the computing device comprising: a location data processing module configured to receive location data from a location sensor of the computing device and output location information; a sound data processing module configured to receive audio data from a microphone of the computing device and output audio information relating to one or more non-verbal sounds of an environment of the computing device captured by the microphone; and an augmentation module configured to: receive the location information and the audio information; generate augmented location data, the augmented location data comprising the location information and the audio information; and output the augmented location data for storage in a data store.

### BACKGROUND

Background information on sound recognition systems and methods can be found in the applicant's PCT application WO2010/070314, which is hereby incorporated by reference in its entirety.

The present applicant has recognised the potential for new applications of sound recognition systems.

### FIELD

The present disclosure generally related to monitoring sound events in a computer monitored environment, and triggering computer implemented actions in response to such sound events.

### SUMMARY

Embodiments of the present disclosure relate to combining location information and audio information to provide location information augmented with audio information.

In particular, embodiments of the present disclosure make use of automatic sound event detection to perform finer grained measurements associated with particular sound events, i.e., reporting that dog bark is stressful, that traffic is producing noise exposure, or that noise in a club or café is speech babble versus loud music. The value added by sound recognition is therefore a more automatic, fine grained and accurate way of reporting information about the acoustic properties of a particular location environment.

According to one aspect of the invention there is provided a computing device, the computing device comprising: a location data processing module configured to receive location data from a location sensor of the computing device and output location information; a sound data processing module configured to receive audio data from a microphone of the computing device and output audio information relating to one or more non-verbal sounds of an environment of the computing device captured by the microphone; and an augmentation module configured to: receive the location information and the audio information; generate augmented location data, the augmented location data comprising the location information and the audio information; and output the augmented location data for storage in a data store.

Thus, by measuring the amount of traffic noise along roads identified by location, and reporting that into the data store (e.g. an augmented location database), users can query the data store and access statistics about the times where the road is noisier, in case they wish to take a quieter route (e.g. when cycling).

Similarly, by measuring the amount of noise in public places, for example the amount of speech babble noise in a café, and reporting that into the data store, users can choose quiet places, e.g., for some relaxing time or for a date.

By associating locations with audio properties such as acoustic noise levels, stressful sounds or sounds which present a health risk (stress or loss of hearing) or any risk associated with noise exposure (e.g., stress accumulated across the day), users querying the data store can make choices to minimise mental or health risks related to exposure to sound or noise, or to maximise their well-being (e.g., find quiet places).

Furthermore, embodiments of the present disclosure assist with managing workers' exposure to noise in industrial settings, e.g., power plants, building sites, airports etc.

Advantageously, the location service operation can be controlled by the sound recognition, e.g., the location data processing module may be controlled to identify a location only when certain sounds happen to limit privacy exposure, or turn off location services automatically if the sound scene indicates a desire for privacy. This can have security advantages, e.g., override the location privacy settings and report a location in case of sounds indicative of an emergency.

The audio information may comprise a sound recognition identifier indicating a target sound or scene that has been recognised based on the audio data.

The audio information may comprise audio measurement data associated with the one or more non-verbal sounds.

The audio measurement data may comprise one or more of (i) a volume sound level value associated with the one or more non-verbal sounds; (ii) a volume sound level identifier indicative of the volume sound level of the one or more non-verbal sounds; (iii) an indication as to whether the one or more non-verbal sounds present a health risk or a health benefit; (iv) a descriptor indicating an effect of an audio feature associated with the one or more non-verbal sounds; and (v) a descriptor recommending a user action to be taken in view of an audio feature associated with the one or more non-verbal sounds.

The audio information may comprise a time identifier associated with said one or more of a non-verbal sound event and a scene.

The time identifier may comprise at least one of: a start time of said one or more of a non-verbal sound event and a scene; an end time of said one or more of a non-verbal sound event and a scene; and a duration of said one or more of a non-verbal sound event and a scene.

The audio information may comprise a date identifier indicating a day on which the audio data is captured.

The location information may comprise one or more of: location co-ordinates, a geocode; and a location identifier.

The location information may comprise the location identifier, and the location data processing module may be configured to obtain said location identifier by querying the data store with the location data, and in response, receiving the location identifier from the data store.

The location data processing module may be configured to continuously output location information based on location data received from the location sensor.

The sound data processing module may be configured to control the output of location information from the location data processing module.

The sound data processing module may be configured to control the location data processing module to output location information in response to detecting that one or more target sound or scene that has been recognised based on the audio data.

The sound data processing module may be configured to control the location data processing module to not output location information in response to detecting that one or more target sound or scene has been recognised based on the audio data.

The computing device may comprise a data store interface controller, and the data store; wherein the augmentation module may be configured to output the augmented location data to the data store interface controller for storage in the data store.

The augmentation module may be configured to output the augmented location data to a remote device, the remote device may comprise a data store interface controller and the data store.

The data store interface controller may be configured to receive a query from a user device.

The computing device may be one of: a smart phone; a smart speaker; a smart photo frame; a smart assistant; a smart home device; a security camera; an in-vehicle device; a wearable device; a hearable device; an augmented reality or virtual reality headset; a piece of smart sport equipment; a piece of smart city equipment; a smart vending machine; a patient health monitoring device; an elderly assistance device; a staff or worker monitoring device; a noise compliance monitoring device.

According to another aspect there is provided a computer implemented method implemented on a computing device, the computer implemented comprising: receiving location data from a location sensor of the computing device and determining location information from said location data; receiving audio data from a microphone of the computing device, and processing said audio data to generate audio information relating to one or more non-verbal sounds of an environment of the computing device captured by the microphone; generating augmented location data, the augmented location data comprising the location information and the audio information; and outputting the augmented location data for storage in a data store.

In a related aspect there is provided a non-transitory data carrier carrying processor control code which when running on a processor of device causes the device to operate as described herein.

The invention further provides processor control code to implement the above-described systems and methods, for example on a general purpose computer system, a digital signal processor (DSP) or a specially designed math acceleration unit such as a Graphical Processing Unit (GPU) or a Tensor Processing Unit (TPU). The invention also provides a carrier carrying processor control code to, when running, implement any of the above methods, in particular on a non-transitory data carrier—such as a disk, microprocessor, CD- or DVD-ROM, programmed memory such as read-only memory (Firmware), or on a data carrier such as an optical or electrical signal carrier. The code may be provided on a carrier such as a disk, a microprocessor, CD- or DVD-ROM, programmed memory such as non-volatile memory (e.g. Flash) or read-only memory (Firmware). Code (and/or data) to implement embodiments of the invention may comprise source, object or executable code in a conventional programming language (interpreted or compiled) such as C, or assembly code, code for setting up or controlling an ASIC (Application Specific Integrated Circuit), FPGA (Field Programmable Gate Array), GPU (Graphical Processing Unit), TPU (Tensor Processing Unit) or NPU (Neural Processing Unit), or code for a hardware description language such as Verilog™ or VHDL (Very high speed integrated circuit Hardware Description Language). As the skilled person will appreciate such code and/or data may be distributed between a plurality of coupled components in communication with one another. The invention may comprise a controller which includes a microprocessor, working memory and program memory coupled to one or more of the components of the system. The invention may comprise performing a DNN operation on a GPU and/or an Al accelerator microprocessor, and performing other operations on a further processor.

It will be appreciated that the functionality of the devices we describe may be divided across several modules and/or partially or wholly implemented in the cloud. Alternatively, the functionality may be provided in a single module or a processor. The or each processor may be implemented in any known suitable hardware such as a microprocessor, a Digital Signal Processing (DSP) chip, an Application Specific Integrated Circuit (ASIC), Field Programmable Gate Arrays (FPGAs), a Graphical Processing Unit (GPU), a Tensor Processing Unit (TPU), and so forth. The or each processor may include one or more processing cores with each core configured to perform independently. The or each processor may have connectivity to a bus to execute instructions and process information stored in, for example, a memory.

These and other aspects will be apparent from the embodiments described in the following. The scope of the present disclosure is not intended to be limited by this summary nor to implementations that necessarily solve any or all of the disadvantages noted.

### BRIEF DESCRIPTION OF THE DRAWINGS

For a better understanding of the present disclosure and to show how embodiments may be put into effect, reference is made to the accompanying drawings in which:

FIG. 1 shows a schematic diagram of a system according to an embodiment;

FIG. 2a shows a block diagram of a system according to an embodiment;

FIG. 2b shows a block diagram of a system according to an embodiment;

FIG. 3 is a flow chart illustrating a process according to an embodiment;

FIG. 4 is a schematic diagram illustrating an implementation of an embodiment;

### DETAILED DECRIPTION

Embodiments described herein relate to providing improved location services by augmenting location data with audio information relating to the recognition of non-verbal sounds (i.e. a non-speech sound event). The non-verbal sound may be any non-speech sound that may be generated in an environment of a user for example a breaking glass sound, smoke alarm sound, baby cry sound etc. The non-verbal sound may be a sound produced by a human (e.g. paralinguistic speech such as laughter or coughing) or an animal. The non-verbal sound may be a vocal sound such as onomatopoeia (for example the imitation of animal sounds). This is in contrast to known voice assistant devices that typically respond to the detection of a human speaking a command word.

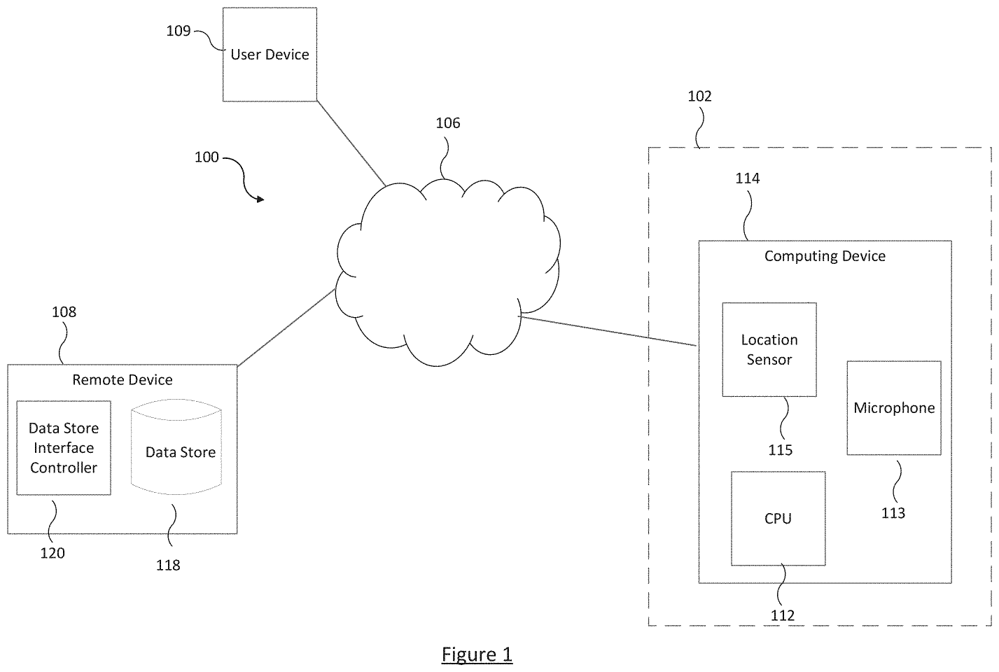

FIG. 1 shows a block diagram of a system 100 comprising example devices. The system 100 comprises devices connected via a network 106. The system 100 comprises a remote device 108, a user device 109, and a computing device 114. These devices may be connected to one another wirelessly or by a wired connection, for example by the network 106.

The computing device 114 comprises a location sensor 115 configured to capture location data. The computing device 114 is positioned in an environment 102 (which may be an indoor or outdoor environment). The computing device 114 comprises a microphone 113 configured to capture audio data. The microphone 113 is configured to capture audio data relating to one or more non-verbal sounds of the environment 102 of the computing device 114.The computing device may be, for example, a smart phone; a smart speaker; a smart photo frame; a smart assistant; a smart home device; a security camera; an in-vehicle device; a wearable device; a hearable device; an augmented reality or virtual reality headset; a piece of smart sport equipment; a piece of smart city equipment; a smart vending machine; a patient health monitoring device; an elderly assistance device; a staff or worker monitoring device; a noise compliance monitoring device.

As explained in further detail below, the computing device 114 is configured to output augmented location data for storage in a data store 118.

FIG. 1 shows a remote device comprising the data store 118 configured to store the augmented location data. The remote device 108 comprises a Data Store Interface Controller configured to communicate with the computing device 114 and store the augmented location data in the data store 118.

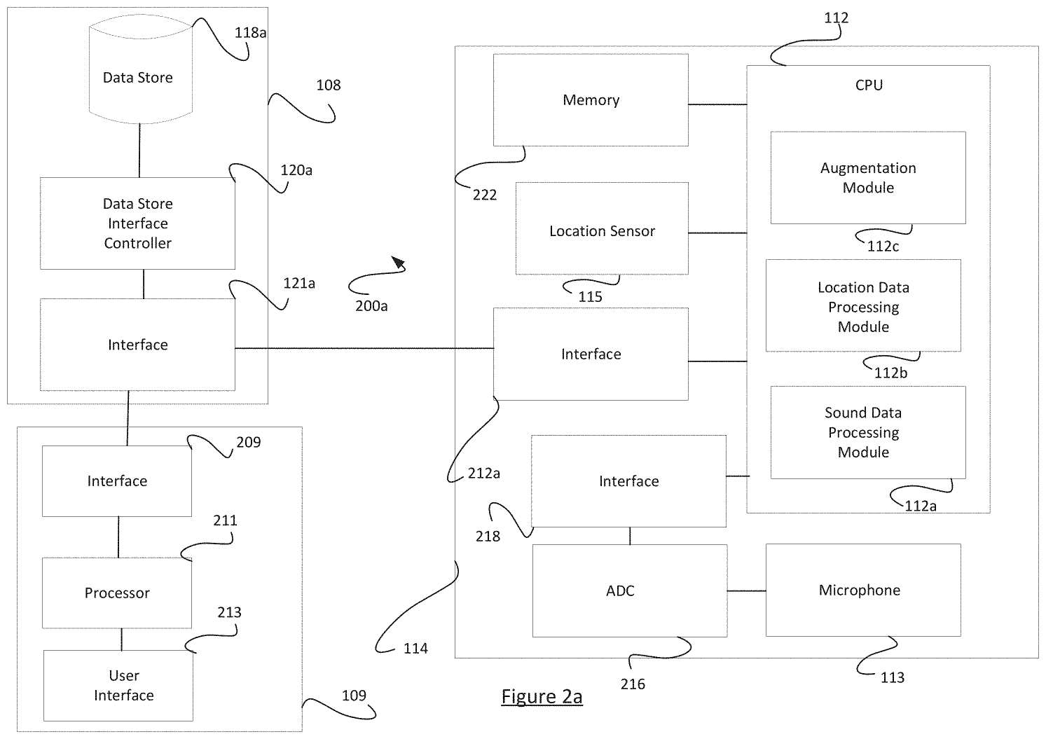

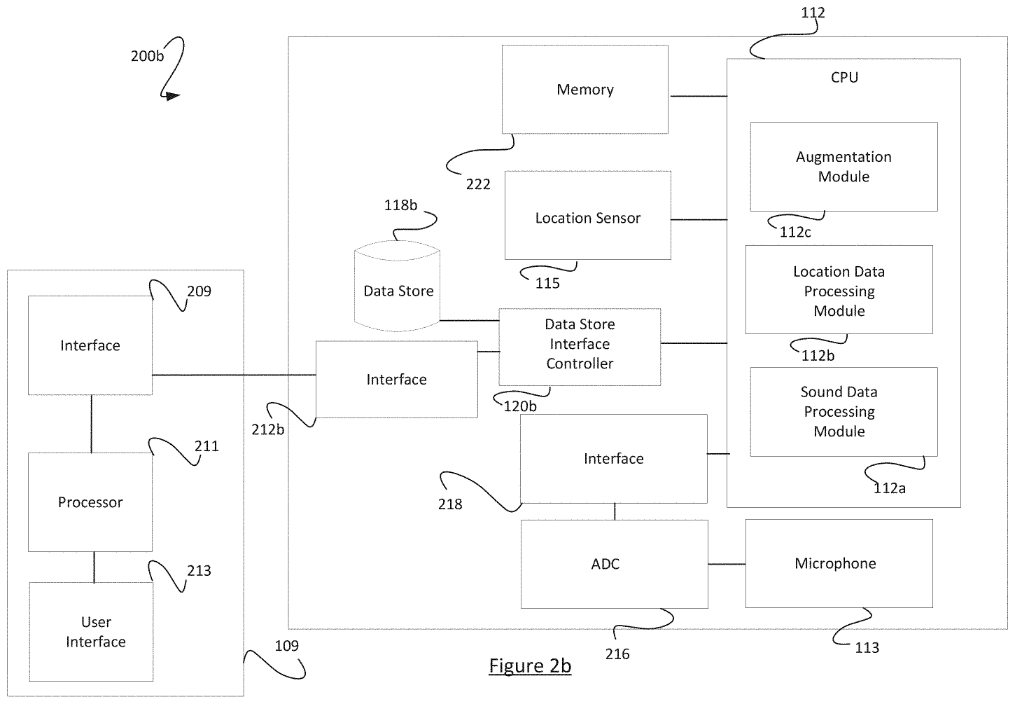

Although the data store 118 is shown as a component of the remote device 108, in embodiments the data store 118 may be positioned on the computing device 114, this is shown in more detail in FIG. 2b.

FIG. 1 further shows a user device 109. The user device 109 is configured to query the data store interface controller 120 for augmented location data stored in the data store 118.

FIG. 2a shows a block diagram of a system 200a comprising the computing device 114 in communication with the remote device 108a and further shows the user device 109 in communication with the remote device 108a. FIG. 2a shows an embodiment in line with the system 100 of FIG. 2.

FIG. 2a shows the computing device 114 comprising a memory 222, a CPU 112, an interface 212a, a microphone 113, an analogue to digital converter 216, an interface 218, and a location sensor 115. The interface 212a is configured to communicate wirelessly or via wired connection with an interface 121a of the remote device 108a and the CPU 112. The interface 218 is configured to communicate wirelessly or via wired connection with the analog to digital convertor 216 and the CPU 112. The CPU 112 is connected to each of: the memory 222; the interface 212a, an interface 218, and a location sensor 115. The computing device 114 may further comprise a user interface (not shown), to allow a user to interface with the device, such a user interface may be for example a display screen, the microphone 113 in conjunction with a speaker, or any other user interface.

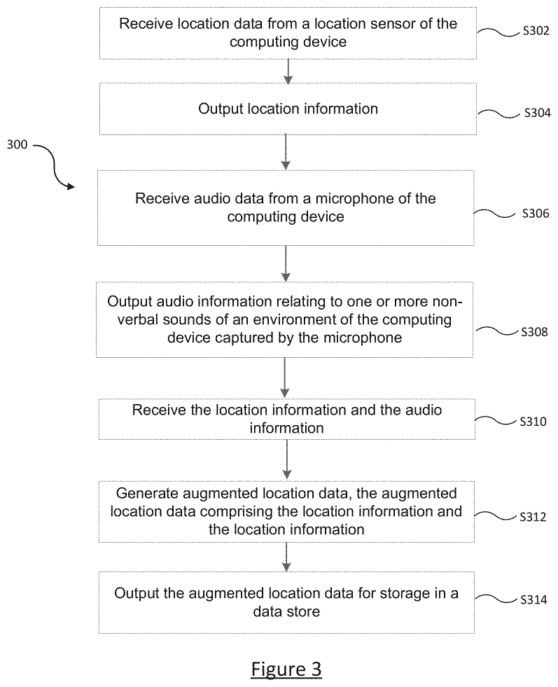

The CPU 112 of the computing device 114 is configured to perform the method illustrated in FIG. 3. The CPU 112 comprises an augmentation module 112c a location data processing module 112b and a sound data processing module 112a. As part of the method of FIG. 3, the CPU 112 of the computing device 114 is configured to receive audio data from the microphone 113.

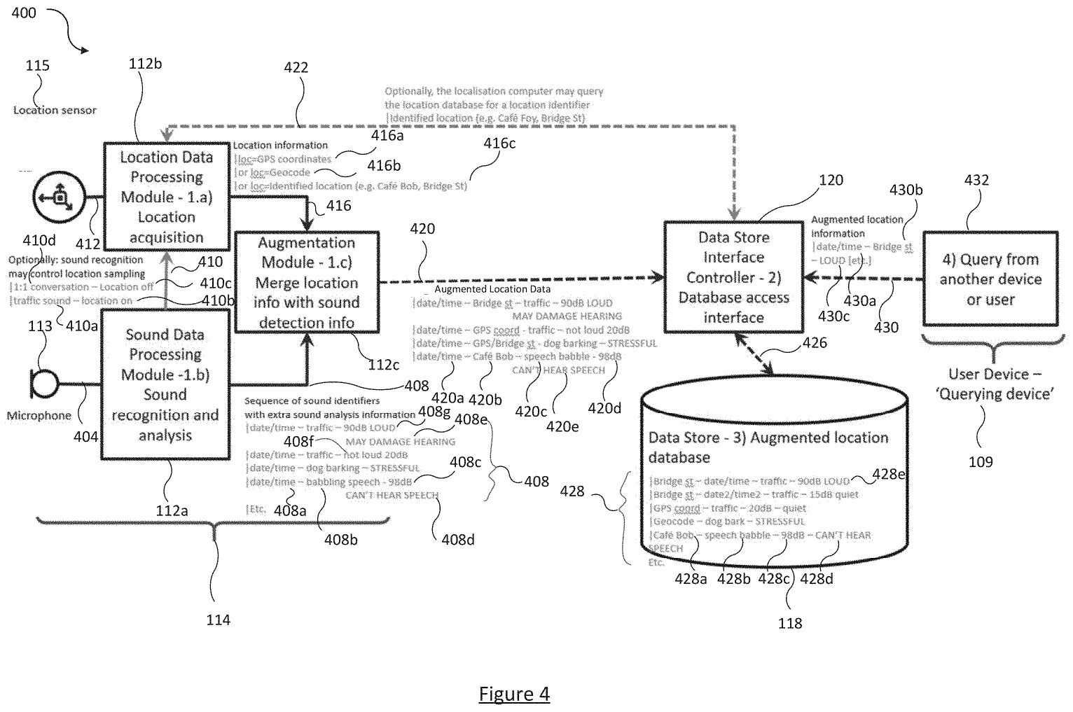

The sound data processing module 112a of the CPU 112 is configured to process sound (i.e the audio data) captured by the microphone 113. As will be explained with reference to FIG. 4-6, the sound data processing module 112a of the CPU 112 may process the captured sound in a number of different ways before sending the processed captured sound (i.e. the audio information) to the augmentation module 112c. The CPU 112 may comprise one or more of a CPU module and a DSP module. The memory 222 is configured to store computer code that when executed by the sound data processing module 112a of the CPU 112, causes the sound data processing module 112a to process the captured sound to generate the audio information. In embodiments, memory 222 is configured to store computer code that when executed by the sound data processing module 112a of the CPU 112, causes the sound data processing module 112a to process the captured sound to recognise a target non-verbal sound and/or scene.

The microphone 113 is configured to convert a sound into an audio signal. The audio signal may be an analog signal, in which case the microphone 113 is coupled to the CPU 112 via the interface 218. The ADC 216 is configured to convert the analog audio signal into a digital signal, in embodiments, the digital signal outputted by the ADC216 is the audio data. The digital audio signal can then be processed by the CPU 112. In embodiments, a microphone array (not shown) may be used in place of the microphone 113.

The location data processing module 112b determines a location of the computing device 114. The location data processing module 112b uses geographic location technology for determining the location of the computing device 114, in terms of geographic position relative to the surface of the earth; for example, a satellite based positioning system such as GPS (Global Positioning System, including potential variants such as assisted GPS or differential GPS), GLONASS (Global Navigation Satellite System) or Galileo; and/or trilateration (or more generally multilateration) relative to a plurality of different wireless base stations or access points having known locations; and/or a technique based on detecting signal strength relative to a known base station or access point. Other well-known methods may be used for the computing device 114 to determine its location.

The computing device 114 may be a wearables device, a hearable device, a smart phone, an automotive device (such as a vehicle or a device for a vehicle), or a smart speaker.

The remote device 108a may be configured to communicate with the user device 109. The remote device 108a comprises a data store 118a, a data store interface controller 120a and an interface 121a. The data store 118a is connected to the data store interface controller 120a. The data store interface controller 120a is connected to the interface 121. The remote device 108a is configured to communicate with the computing device 114 and the user device 109 via the interface 121a. The data store interface controller 120a of the remote device 108a is configured to store the augmented location data outputted by the computing device 114 for storage in the 118a data store. Additionally, the remote device 108a is configured to receive queries from the user device 109. The queries are for data stored in, or obtained from, the data store 118a.

The user device 109 comprises an interface 209, a processor 211 and a user interface 213. The processor 211 is connected to the user interface 213 and further to the interface 209. The user interface 213 is configured to allow a user to interface with the user device to send a query for augmented location data stored in the data store 118a. The user device 109 may be a wearables device, a hearable device, a smart phone, an automotive device (such as a vehicle or a device for a vehicle), or a smart speaker.

FIG. 2a shows an embodiment where the data store 118a and the data store interface controller 120a are on the remote device 108a. FIG. 2b shows an embodiment where the data store 118a and the data store interface controller 120a are on the same device as the location sensor 115 and the microphone 113 (i.e. on the computing device 114). FIG. 2b will be described in more detail below.

FIG. 2b shows a block diagram of a system 200a comprising the computing device 114 in comprising a data store 118b and a data store interface controller 120b and further shows the user device 109 in communication with the computing device 114.

FIG. 2b shows the computing device 114 comprising a memory 222, a CPU 112, an interface 212b, a microphone 113, an analog to digital convertor 216, an interface 218, a location sensor 115, data store 118b and the data store interface controller 120b. The interface 212b is configured to communicate wirelessly or via wired connection with an interface 121a the user device 109 and the data store interface controller 120b. The interface 218 is configured to communicate wirelessly or via wired connection with the analog to digital convertor 216 and the CPU 112. The CPU 112 is connected to each of: the memory 222; the data store interface controller 120b; the interface 212b via the data store interface controller 120b; an interface 218, and a location sensor 115. The computing device 114 may further comprise a user interface (not shown), to allow a user to interface with the device, such a user interface may be for example a display screen, the microphone 113 in conjunction with a speaker, or any other user interface.

The CPU 112 of the computing device 114 is configured to perform the method illustrated in FIG. 3. The CPU 112 comprises an augmentation module 112c a location data processing module 112b and a sound data processing module 112a. As part of the method of FIG. 3, the CPU 112 of the computing device 114 is configured to receive audio data from the microphone 113.

The sound data processing module 112a of the CPU 112 is configured to process sound (i.e the audio data) captured by the microphone 113. As will be explained with reference to FIG. 4-6, the sound data processing module 112a of the CPU 112 may process the captured sound in a number of different ways before sending the processed captured sound (i.e. the audio information) to the augmentation module 112c. The CPU 112 may comprise one or more of a CPU module and a DSP module. The memory 222 is configured to store computer code that when executed by the sound data processing module 112a of the CPU 112, causes the sound data processing module 112a to process the captured sound to generate the audio information. In embodiments, memory 222 is configured to store computer code that when executed by the sound data processing module 112a of the CPU 112, causes the sound data processing module 112a to process the captured sound to recognise a target sound event and/or scene.

The microphone 113 is configured to convert a sound into an audio signal. The audio signal may be an analog signal, in which case the microphone 113 is coupled to the CPU 112 via the interface 218. The ADC 216 is configured to convert the analog audio signal into a digital signal, in embodiments, the digital signal outputted by the ADC 216 is the audio data. The digital audio signal can then be processed by the CPU 112. In embodiments, a microphone array (not shown) may be used in place of the microphone 113.

The location data processing module 112b determines a location of the computing device 114. The location data processing module 112b uses geographic location technology for determining the location of the computing device 114, in terms of geographic position relative to the surface of the earth; for example, a satellite based positioning system such as GPS (Global Positioning System, including potential variants such as assisted GPS or differential GPS), GLONASS (Global Navigation Satellite System) or Galileo; and/or trilateration (or more generally multilateration) relative to a plurality of different wireless base stations or access points having known locations; and/or a technique based on detecting signal strength relative to a known base station or access point. Other known methods may be used for the computing device 114 to determine its location.

The computing device 114 may be may be a wearables device, a hearable device, a smart phones, an automotive device (such as a vehicle or a device for a vehicle), or a smart speaker.

The computing device 114 of FIG. 2b further comprises the data store 118b, a data store interface controller 120b. The data store 118b is connected to the data store interface controller 120b. The data store interface controller 120b is connected to the CPU 112. The data store interface controller 120b is configured to communicate with the user device 109 via the interface 212b. The data store interface controller 120b is configured to store the augmented location data outputted by the CPU 112 for storage in the data store 118b. Additionally, the data store interface controller 120b is configured to receive queries from the user device 109. The queries are for data stored in, or obtained from, the data store 118a.

The user device 109 comprises an interface 209, a processor 211 and a user interface 213. The processor 211 is connected to the user interface 213 and further to the interface 209. The user interface 213 is configured to allow a user to interface with the user device to send a query for augmented location data stored in the data store 118b. The user device 109 may be a wearables device, a hearable device, a smart phone, an automotive device (such as a vehicle or a device for a vehicle), or a smart speaker.

FIG. 3 shows a flow chart of actions performed by the CPU 112 of FIG. 2a and FIG. 2b.

At step S302, the Location Data Processing Module 112b of the CPU 112 receives location data from the location sensor 115 of the computing device.

At step S304, the Location Data Processing Module 112b of the CPU 112 and determines location information from the location data and outputs the location information.

At step S306, the Sound Data Processing Module 112a receives audio data from the microphone 113 of the computing device.

At step S308, the Sound Data Processing Module 112a is configured to process the audio data to generate audio information relating to one or more non-verbal sounds of an environment of the computing device captured by the microphone and output the audio information.

At step S310, the Augmentation Module 112c of the CPU 112 receives the location information and the audio information.

At step S312, the Augmentation Module 112c of the CPU 112 generates augmented location data, the augmented location data comprising the location information and the audio information.

At step S314, the CPU 112 is configured to output the augmented location data for storage in a data store. As described above, the data store may be remote to the computing device 114 (as illustrated in FIG. 2a) or the data store may be local to the computing device 114 (as illustrated in FIG. 2b).

FIG. 4 is a schematic diagram illustrating an implementation of an embodiment of the present disclosure. FIG. 4 shows the three modules of the CPU 112 of the computing device 114.

Sound Data Processing Module

As can be seen, the sound data processing module 112a (i.e. the sound data processing module 112a of FIGS. 2a and 2b) receives audio data from the microphone 113 (at the transmission 404). The sound data processing module 112a processes the audio data and outputs audio information 408. The audio information 408 relates to one or more non-verbal sounds of an environment of the computing device captured by the microphone 113. As example process performed by the sound data processing module 112a to generate audio information 408 is described below.

The sound data processing module 112 is configured to receive the audio data. The sampling frequency of the audio data may be 16 kHz, this means that 16,000 audio samples are taken per second. The digital audio sample is grouped into a series of 32 ms long frames with 16 ms long hop size, see the sequence of waveform samples 438. If the sampling frequency is 16 Khz, then this is equivalent to the digital audio sample being grouped into a series of frames that comprise 512 audio samples with a 256 audio samples-long hop size.

Once the digital audio sample has been acquired, feature extraction is performed on the frames of the digital audio samples. The feature extraction results in a sequence of acoustic feature frames. The feature extraction step comprises transforming the sequence of waveform samples into a series of multidimensional feature vectors (i.e. frames), for example emitted every 16 ms. The feature extraction of step may be implemented in a variety of ways.

One implementation of feature extraction step is to perform one or more signal processing algorithms on the sequence of waveform samples. An example of a signal processing algorithm is an algorithm that processes a power spectrum of the frame, for example obtained using the fast Fourier transform (FFT), to extract a spectral flatness value for the frame. A further example is a signal processing algorithm that extracts harmonics and their relative amplitudes from the frame.

An additional or alternative implementation of the acoustic feature extraction step is to use a Deep Neural Network (DNN) to extract a number of acoustic features for a frame. A DNN can be configured to extract audio feature vectors of any dimension. A bottleneck DNN embedding or any other appropriate DNN embedding may be used to extract acoustic features. Here a neural network bottleneck may refer to a neural network which has a bottleneck layer between an input layer and an output layer of the neural network, where a number of units in a bottleneck layer is less than that of the input layer and less than that of the output layer, so that the bottleneck layer is forced to construct a generalised representation of the acoustic input.

The acoustic feature frames are then processed to recognise a sound and/or scene, this processing can be performed in a number of ways, an embodiment will be described below.

A first step of recognising a sound and/or scene comprises an acoustic modeling step classifying the acoustic features to classify the frame by determining, for each of a set of sound classes, a score that the frame represents the sound class. In an embodiment, the acoustic modeling step comprises using a deep neural network (DNN) trained to classify each incoming acoustic feature vector into a sound class (e.g. glass break, dog bark, baby cry etc.). Therefore, the input of the DNN is an acoustic feature vector and the output is a score for each sound class. The scores for each sound class for a frame may collectively be referred to as a frame score vector. For example, the DNN used may be configured to output a score for each sound class modeled by the system every 16ms.

An example DNN used is a feed-forward fully connected DNN having 992 inputs (a concatenated feature vector comprising 15 acoustic vectors before and 15 acoustic vectors after a central acoustic vector=31 frames×32 dimensions in total). The example DNN has 3 hidden layers with 128 units per layer and RELU activations.

Alternatively, a convolutional neural network (CNN), a recurrent neural network (RNN) and/or some other form of deep neural network architecture or combination thereof could be used.

Following the described acoustic modeling step classifying the acoustic features, long-term acoustic analysis is performed. The long-term acoustic analysis comprises processing the sound class scores for multiple frames of the sequence of frames to generate, for each frame, a sound class decision for each frame. The long-term acoustic analysis outputs frame-level classification decisions after integrating longer term temporal information, typically spanning one or several seconds, into the frame-level scoring.

As an example, if there are four sound classes: A, B, C and D, the long-term acoustic analysis performed will comprise receiving a sequence of vectors. Each vector would have four dimensions, where each dimension represents a (optionally reweighted) score for a class. The long-term acoustic analysis performed at comprises processing the multiple vectors that represent a long-term window, typically 1.6 second/100 score values long context window. The long-term acoustic analysis will then comprise outputting a series of classification decisions for each frame (i.e. the output will be A, B, C or D for each frame, rather than 4 scores for each frame). The long-term acoustic analysis therefore uses information derived from frames across a long-term window.

The long-term acoustic analysis can be used in conjunction with external duration or co-occurrence models. For example:
Transition matrices can be used to impart long-term information and can be trained independently of Viterbi. Transition matrices are an example of a co-occurrence model and also implicitly a duration model. Co-occurrence models comprise information representing a relation or an order of events and/or scenes.
An explicit model of duration probabilities can be trained from ground truth labels (i.e. known data), for example fitting a Gaussian probability density function on the durations of one or several baby cries as labeled by human listeners. In this example, a baby cry may last between 0.1 s and 2.5 s and be 1.3 s long on average. More generally, the statistics of duration can be learned from external data. For example, from label durations or from a specific study on a duration of a specific sound event and/or scene.
Many types of model can be used as long as they are able to generate some sort of class-dependent duration or co-occurrence score/weight (e.g., graphs, decision trees etc.) which can, for example, be used to rescore a Viterbi path(s), or alternatively, be combined with the sound class scores by some method other than the Viterbi algorithm across the long term, for example across a sequence of score frames spanning 1.6 s.

Examples of the long-term acoustic analysis are given below, where the long-term acoustic analysis may thus apply a temporal structure constraint.

Score smoothing and thresholding

Viterbi optimal path search

a recurrent DNN trained to integrate the frame decisions across a long-term window.

In more detail:
a) Score smoothing and thresholding across long term window

Median filtering or some other form of long-term low-pass filtering (for example a moving average filter) may be applied to the score values spanned by the long-term window. The smoothed scores may then be thresholded to turn the scores into class decisions, e.g., when a baby cry score is above the threshold then the decision for that frame is baby cry, otherwise the decision is world (“not a baby”). There is one threshold per class/per score.

b) Viterbi optimal path search across a long term window

Examples of using the Viterbi algorithm to perform the long-term acoustic analysis comprises:· A state-space definition: there are S states where each state (s_i) is a sound class, for example: s_0==world; s_1==baby_cry; s_2==glass_break; etc. In one configuration there are 6 states however, in general there are as many states as there are classes to be recognised plus an extra state representing all other sounds (labeled as a ‘world’ class (i.e. a non-target sound class) in the above).
An array of initial probabilities: this is a S-sized array, where the i-th element is the probability that the decoded sequence starts with state i. In an example, these probabilities are all equal (for example, all equal to 1/S).
A transition matrix A: this is a S×S matrix where the element (i, j) is the probability of moving from state i to state j. In an example configuration, this matrix is used to block transitions between target classes, for example, the probabilities of the row 0 (world class) are all greater than zero, which means a state can move from world to all other target classes. But, in row 1 (baby cry) only columns 0 and 1 are non-zero, which means that from baby cry the state can either stay in the baby cry state or move to the world state. Corresponding rules apply for the other rows.

An emission matrix: this is a N×S matrix where the element (i, j) is the score (given by the acoustic model, after warping) of observing class j at the time frame i. In an example, N is equal to 100. In this example, the time window is 100 frames long (i.e. 1.6 seconds) and it moves with steps of 100 frames, so there is no overlap.

In other words, every time that the Viterbi algorithm is called, the Viterbi algorithm receives as an input, for example, 100 sound class scores and outputs 100 sound class decisions.

The settings are flexible, i.e., the number of frames could be set to a longer horizon and/or the frames could overlap.

Transition matrices can be used to forbid the transition between certain classes, for example, a dog bark decision can be forbidden to appear amongst a majority of baby cry decisions.

c) DNN across a long-term window

Examples of a DNN used to perform the long-term acoustic analysis performed are:

A long short-term memory recurrent neural network (LSTM-RNN) with 101 stacked frame score vectors (50 frames before and after a target frame), where score frame vectors contain 6 scores (one for each of 6 classes) as input. Thus, the input size is a 101 by 6 tensor. The rest of the DNN comprises 1 LSTM hidden layer with 50 units, hard sigmoid recurrent activation, and tanh activation. The output layer has 6 units for a 6-class system.

A gated recurrent units RNN (GRU-RNN): the input size is similarly a 101 by 6 tensor, after which there are 2 GRU hidden layers with 50 units each, and tanh activation. Before the output layer a temporal max pooling with a pool size of 2 if performed. The output layer has 6 units for a 6-class system.

Long-term information can be inflected by external duration or co-occurrence models, for example transition matrices in case c) of using a Viterbi optimal path search, or inflected by an external model made by learning the typical event and/or scene lengths, for example probabilities of event and/or scene duration captured by some machine learning method, typically DNNs.

The sound and/or scene recognition further comprises processing the sound class decisions for a sequence of frames to recognise a non-verbal sound event and/or scene. In an example, the sound class decisions for multiple frames are input and an indication of one or more non-verbal sound events and/or scenes are output. Examples of how this may be performed are explained below, one or more of the below examples may be implemented:
a) the sound class decisions for each frame may be grouped into long-term event and/or scene symbols with a start time, an end time and a duration;
b) discarding a sequence of sound class decisions of the same class which are shorter than a sound event and/or scene duration threshold defined individually for each sound class. For example: a sequence of “baby cry” sound class decisions can be discarded if the sequence of “baby cry” sound class decisions are collectively shorter than 116 milliseconds (which is approximately equivalent to 10 frames); a sequence of “smoke alarm” sound class decisions can be discarded if the sequence of “smoke alarm” sound class decisions are collectively shorter than 0.4 seconds (which is approximately equivalent to 25 frames). The sound event and/or scene duration thresholds can be set manually for each class;
c) merging multiple non-verbal sound events and/or scenes of the same sound class that intersect a particular time window into one single non-verbal sound event and/or scene. For example, if two “baby cry” non-verbal sound events and/or scenes are determined to happen within a 4 seconds interval then they are merged into one a single “baby cry” non-verbal sound events and/or scenes, where the window duration (4 seconds in the above example) is a parameter which can be manually tuned. The window duration can be different for each sound class.

An output of the sound data processing module 112a is audio information 408. The audio information may comprise a sequence of one or more sound identifiers with extra sound analysis information, this is illustrated in FIG. 4. The audio information 408 comprises a sound recognition identifier 408b indicating a target sound or scene that has been recognised based on the audio data. For example, the sound identifier 408b (e.g. ‘babbling speech’) associated with a date and/or time 408a.

The audio information 408 may comprise time identifier 408a associated with the sound event and/or scene identified by the sound identifier 408b, this may be for example a time identifier such as a start time of the sound event and/or scene, an end time of the sound event and/or scene, and/or a duration of the sound event and/or scene. The audio information 408 may comprise a date identifier 408a indicating a day on which the audio data is captured in addition to a time identifier indicating a time at which the audio data is captured.

The audio information may comprise audio measurement data associated with the one or more non-verbal sounds or events. In other words, the audio information 408 may comprise audio measurement data (e.g. the sound level ‘98 dB’ 408c) associated with the target sound and/or scene identified by the sound identifier 408. For example, the audio measurement data may comprise a sound level value associated with the one or more non-verbal sounds, see 408c that indicates the sound is ‘98 dB’.

In another example, generating the audio measurement data may comprise signal processing to determine the level of certain frequencies or combinations of frequencies, the crossing of pre-define threshold curves, or certain acoustic properties of the audio spectrum such as spectrum slope, spectral entropy which translate into psychoacoustic properties. For example, the audio measurement data may comprise a sound level identifier indicative of the sound level of the one or more non-verbal sounds, for example 408f ‘not loud’ is an indicator of the sound level of the one or more non-verbal sounds, a further example is 408g ‘Loud’. The audio measurement data may comprise an indication as to whether the one or more non-verbal sounds present a health risk or a health benefit, this can be seen at 408e which indicates that the loud noise may damage hearing. The audio measurement data may comprise an indication as to whether the one or more non-verbal sounds represent value that can be exploited by the user, for example 408d which indicates to the user that the identified ‘babbling speech’ may result in the user being unable to hear speech from another person if dialoguing in that environment. Generating such examples of audio feature identifiers may comprise converting audio properties (such as frequency, sound level) of the audio data captured by the microphone 113 (and received at the transmission 404) using a series of rules, or using a machine learning model trained to output audio feature identifiers (such as ‘loud’, ‘stressful’, ‘damaging to health’) having received audio data or properties of audio data as an input. The series of rules may be obtained from a previous study(s), where the previous study indicates that, for example, an audio property (e.g. sound level above 70 dB and/or frequency below 200 Hz) will correspond to a psychoacoustic property(s) (e.g. ‘stress’ , ‘peace’ etc). Rather than a series of rules obtained from a study, a machine learning model may be trained to convert audio properties into psychoacoustic properties. For example, if audio data and their corresponding acoustic features are labeled with semantic properties (e.g. sound level identifiers) then the machine learning can be trained from the labeled data. The machine learning model may be, for example, a decision tree or a deep neural network.

Audio feature identifiers from audio measurements may be considered to include psychoacoustic properties because they pertain to the effect on a user, for example the user defines what is loud or not. The term psychoacoustic properties is used in a broad sense to encompass phrases such as ‘loud’, ‘quiet’, ‘masking speech’, ‘dangerous’, ‘stressful’, ‘relaxing’ etc

The audio measurement data may comprise a descriptor (e.g. a message for a user) indicating an effect of an audio feature associated with the one or more non-verbal sounds (e.g. “dialogue with a friend won't be intelligible there”). The audio measurement data may comprise a descriptor recommending a user action to be taken in view of an audio feature associated with the one or more non-verbal sounds (e.g. “you may want to wear ear protectors when visiting this factory”). The audio feature may comprise one or more of: a sound level associated with the one or more non-verbal sounds, a level of certain frequencies or combinations of frequencies in the one or more non-verbal sounds, the crossing of pre-define threshold curves or certain acoustic properties of the audio spectrum of the associated with the one or more non-verbal sounds such as spectrum slope or spectral entropy.

Location Data Processing Module

FIG. 4 shows the location sensor 115. FIG. 4 shows the location data processing module 112b that is configured to receive location data 412 from the location sensor 115 of the computing device 114 and output location information 416. The location information 416 may comprise location co-ordinates 416a, a geocode 416b, and/or a location identifier, see 416c (e.g. bridge street, Café Bob).

In some embodiments wherein the location information 416 comprises the location identifier 416c, the location data processing module 112b is configured to obtain the location identifier 416c by querying the data store 118 with the location data 412, and in response, receive the location identifier 416c from the data store 118.

The location data processing module 112b determines a location of the computing device 114. The location data processing module 112b uses geographic location technology for determining the location of the computing device 114, in terms of geographic position relative to the surface of the earth; for example, a satellite based positioning system such as GPS (Global Positioning System, including potential variants such as assisted GPS or differential GPS), GLONASS (Global Navigation Satellite System) or Galileo; and/or trilateration (or more generally multilateration) relative to a plurality of different wireless base stations or access points having known locations; and/or a technique based on detecting signal strength relative to a known base station or access point. Other known methods may be used for the computing device 114 to determine its location.

In some embodiments, the location data processing module 112b may be configured to continuously output location information 416 based on the location data 412 received from the location sensor 115.

In other embodiments, the sound data processing module 112a is configured to control the output of location information 416 from the location data processing module 112b based on a command 410 supplied to the location data processing module 112b. In this embodiment, the sound data processing module 112a is configured to control the location data processing module 112b to output location information in response to detecting that one or more target sound or scene has been recognised based on the audio data. For example, the sound data processing module 112a may be configured to control the location data processing module 112b to not output location information in response to recognising a scene associated with a need for privacy. As an example, FIG. 4 shows an example where a command 410c is output to the location data processing module 112b to turn off the output of the location information 416 because the presence of speech sounds indicative of a dialogue 410d was recognised. FIG. 4 further shows an example where a command 410b is output to the location data processing module 112b to turn on the output of the location information 416 because ‘traffic sound’ 410a was recognised. This can have security advantages, e.g., override the location privacy settings and report a location in case of sounds indicative of an emergency.

Augmentation Module

The augmentation module 112c is configured to receive the location information 416 from the location data processing module 112b. The augmentation module 112c is configured to receive the audio information 408 from the audio data processing module 112a. The augmentation module 112c is configured to generate augmented location data 420. The augmented location data 420 comprises the location information 416 and the audio information 408. This can be seen in FIG. 4 which illustrates that the augmented location data 420 comprises a time identifier 420a which corresponds to the time identifier 408a of the audio information 408. The augmented location data 420 may additionally comprise a date identifier 420a which corresponds to the date identifier 408a of the audio information 408. This can further be seen by way of the augmented location data 420 comprising a sound recognition identifier 420c which corresponds to the sound recognition identifier (e.g. ‘babbling speech’ 408b of the audio information 408. This can be further seen by way of the augmented location data 420 comprising audio measurement data 420d, 420e which corresponds to the audio measurement data ‘98 dB’ (408c) and ‘Can't hear speech’ 408d of the audio information 408. Additionally, the augmented location data 420 comprises location information 420b which corresponds to the location information 416received from the location data processing module 112b. The augmentation module 112c is configured to output the augmented location data 420 for storage in the data store 118.

As the sound data processing module 112a, microphone 113, location sensor 115 and location data processing module 112b are synchronised in time because they are all in the same device, the audio information 408 and location information 416 may be combined into an augmented location data.

In embodiments, if location acquisition is off (for example if the location sensor 115 is turned off), then no augmented location information may be generated. Sound recognition, alternatively, keeps recognising sounds as long as the user authorises it, so that it can control location acquisition. Advantageously, this has a battery saving benefit because sound detection may operate at a lower power than GPS measurements, which may be important if the device is battery operated.

In embodiments, as long as sounds are recognised and/or measurable, and location data is available, then augmented location data messages may be generated. In embodiments, if no sound is recognised or measurable but GPS is on, then no augmented location data is generated.

Data Store

The augmentation module 112c is configured to output the augmented location data 420 to the data store interface controller 120 for storage in the data store 118.

The data store interface controller 120 controls the storing of the augmentation location data 420 in the data store 118. For example, it can be seen that the data store 118 is arranged to store multiple augmented location data entries. One example augmented location data entry is shown in FIG. 4 as comprising the location information ‘café bob’ 428a, sound identifier ‘speech babble’ 428b, the audio measurement data ‘98 dB’ 428c, the audio measurement data ‘Can't hear speech’ 428d.

As discussed above, in one embodiment the computing device 114 comprises the data store interface controller 120 and the data store 118. Alternatively, the remote device 108 may comprise the data store interface controller 120 and the data store 118.

An analytics module (not shown in the Figures) may be coupled to the data store interface controller 120 and the data store 118. The analytics module is configured to analyse the augmented location data entries stored in the data store and output analysis results. The analysis results may comprise statistics computed using the augmented location data entries stored in the data store 118. For example, time schedules of when a road is noisiest or quietest can be computed (e.g. Bridge street is noisiest between 8 am and 9 am on weekdays).

The data store interface controller 120 is configured to receive a query 430 from the user device 109 relating to a particular location to allow a user to access augmented location data associated with that location and make use of it to manage their sound exposure levels.

In response to the query 430 the data store interface controller 120 may supply access one or more augmented location data entries 430 stored in the data store 118 and supply it in raw form to the user device 109.

Additionally or alternatively, in response to the query 430 the data store interface controller 120 may supply analysis results relating to the location in the query that is provided by the analytics module.

For example, in an embodiment the query 430 may be received from the user device 109 via an app on the user device 109 that requires a manual user interaction to generate and/or send the query 430. In another embodiment, the query 430 may be generated and/or sent by a service performing an automatic action, for example an app operating on the user device 109 in charge of guiding a user through a quiet route, or tasked to inform a user about health risks associated with their immediate environment.

Generally, any of the functions described herein can be implemented using software, firmware, hardware (e.g., fixed logic circuitry), or a combination of these implementations. The terms “module,” and “controller” as used herein generally represent software, firmware, hardware, or a combination thereof. In the case of a software implementation, the module or controller represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computing device, the computing device comprising:
a location data processing module configured to receive location data from a location sensor of the computing device and output location information of an environment;
a sound data processing module configured to receive audio data from a microphone of the computing device and configured to automatically output audio information relating to one or more non-verbal sounds or scenes of the environment of the computing device captured by the microphone, wherein the audio information comprises a sound recognition identifier indicating a target non-verbal sound or scene that has been recognized based on an acoustic modeling step applied to the audio data; and
an augmentation module configured to:
receive the location information and the audio information;
generate augmented location data, the augmented location data comprising an association between the location information of the environment and the audio information captured by the microphone at the environment; and
output the augmented location data for storage in a data store.

2. (canceled)

3. The computing device of claim 1, wherein the audio information comprises audio measurement data associated with the one or more non-verbal sounds.

4. The computing device of claim 3, wherein the audio measurement data comprises one or more of (i) a sound level value associated with the one or more non-verbal sounds; (ii) a sound level identifier indicative of the sound level of the one or more non-verbal sounds; (iii) an indication as to whether the one or more non-verbal sounds present a health risk or a health benefit; (iv) a descriptor indicating an effect of an audio feature associated with the one or more non-verbal sounds; and (v) a descriptor recommending a user action to be taken in view of an audio feature associated with the one or more non-verbal sounds.

5. The computing device of claim 1, wherein the audio information comprises a time identifier associated with said one or more of a non-verbal sound event and a scene.

6. The computing device of claim 5, wherein time identifier comprises at least one of:
a start time of said one or more of a non-verbal sound event and a scene;
an end time of said one or more of a non-verbal sound event and a scene; and
a duration of said one or more of a non-verbal sound event and a scene.

7. The computing device of claim 1, wherein the audio information comprises a date identifier indicating a day on which the audio data is captured.

8. The computing device of claim 1, wherein the location information comprises one or more of: location co-ordinates; a geocode; and a location identifier.

9. The computing device of claim 8, wherein the location information comprises the location identifier, and the location data processing module is configured to obtain said location identifier by querying the data store with the location data, and in response, receiving the location identifier from the data store.

10. The computing device of claim 1, wherein the location data processing module is configured to continuously output location information based on location data received from the location sensor.

11. The computing device of claim 1, wherein the sound data processing module is configured to control the output of location information from the location data processing module.

12. The computing device of claim 11, wherein the sound data processing module is configured to control the location data processing module to output location information in response to detecting that one or more target sound or scene that has been recognised based on the audio data.

13. The computing device of claim 11, wherein the sound data processing module is configured to control the location data processing module to not output location information in response to detecting that one or more target sound or scene has been recognised based on the audio data.

14. The computing device of claim 1, wherein the computing device further comprises a data store interface controller, and the data store; wherein the augmentation module is configured to output the augmented location data to the data store interface controller for storage in the data store.

15. The computing device of claim 1, wherein the augmentation module is configured to output the augmented location data to a remote device, the remote device comprising a data store interface controller and the data store.

16. The computing device of claim 1, wherein the data store interface controller is configured to receive a query from a user device.

17. The computing device of claim 1, wherein the computing device is one of: a smart phone; a smart speaker; a smart photo frame; a smart assistant; a smart home device; a security camera; an in-vehicle device; a wearable device; a hearable device; an augmented reality or virtual reality headset; a piece of smart sport equipment; a piece of smart city equipment; a smart vending machine; a patient health monitoring device; an elderly assistance device; a staff or worker monitoring device; a noise compliance monitoring device.

18. A computer implemented method implemented on a computing device, the computer implemented comprising:
receiving location data from a location sensor of the computing device and determining location information of an environment from said location data;
receiving audio data from a microphone of the computing device, and automatically processing said audio data to generate audio information relating to one or more non-verbal sounds or scenes of the environment of the computing device captured by the microphone, wherein the audio information comprises a sound recognition identifier indicating a target non-verbal sound or scene that has been recognized based on an acoustic modeling step applied to the audio data;
generating augmented location data, the augmented location data comprising an association between the location information of the environment and the audio information captured by the microphone at the environment; and
outputting the augmented location data for storage in a data store.

19. A non-transitory data carrier carrying processor control code which when running on a processor of device causes the device to perform the method of claim 18.
